(19) United States
(12) Patent Application Publication
(10) Pub. No.: US 2026/0063016 A1
(43) Pub. Date: Mar. 5, 2026

(54) CENTRIFUGAL PUMP FOR HEATING FLUID BY EDDY CURRENT, AND SUBSEA TOOL FOR HEATING FLUID BY EDDY CURRENT

(71) Applicant: Petróleo Brasileiro S.A. – Petrobras, Rio de Janeiro (BR)

(72) Inventor: Ernani FERNANDES VARGAS DA SILVA, Rio das Ostras (BR)

(73) Assignee: Petróleo Brasileiro S.A. – Petrobras, Rio de Janeiro (BR)

(21) Appl. No.: 19/385,976

(22) Filed: Nov. 11, 2025

Related U.S. Application Data
(62) Division of application No. 17/779,985.

(30) Foreign Application Priority Data
Nov. 26, 2019 (BR) BR 1020190249366

(51) Int. Cl. E21B 36/04; E21B 43/24; F04D 29/58

(52) U.S. Cl. CPC E21B 36/04; E21B 43/24; F04D 29/58

(57) ABSTRACT

The present invention provides a centrifugal pump for heating fluid by eddy current comprising a volute and a cover, in which internally regarding the volute there are provided: an impeller positioned between two supporting annular disks of magnets each comprising a plurality of permanent magnets; and two armatures positioned at the ends of the internal assembly. In addition, the invention also provides a subsea tool for fluid heating by eddy current comprising: a centrifugal pump driven by a hydraulic motor by means of a shaft; a fluid storage tank hydraulically connected to the centrifugal pump; at least one piloted on-off valve; piloted directional valves; and a filter hydraulically connected to the centrifugal pump.

### FIELD OF INVENTION

The present invention is related to technologies of subsea pieces of equipment. More particularly, the present invention relates to a subsea tool for fluid heating by eddy current.

### FUNDAMENTALS OF THE INVENTION

To enable the exploration and production of hydrocarbons in subsea regions, it is necessary to install and uninstall, on the seabed, of various types of pieces of equipment.

These pieces of equipment are intended, for the most part, for the control, containment and flow of different types of fluids, such as in wet Christmas trees (WCT), manifolds, modules for connecting flexible lines, rigid ducts, safety valves (ESDVs), pieces of equipment at duct terminations (PLEM, PLET and ILT), among others.

In general, these pieces of equipment are constructed of several mechanical components, among them: pipes, flanges, sealing rings, on-off valves, directional valves, indicators, sacrificial anodes, mechanical connectors, hydraulic cylinders, hoses, control lines, etc.

In addition, these pieces of equipment are designed to direct the flow of one or more types of fluids, such as water, oils, condensates, gas and several types of contaminants from the accumulation zones (natural reservoirs). The pressures and temperatures of these fluids are also considered in the design stages.

Although all these factors are taken into account in the design and construction stage, during the useful life and operation of these pieces of equipment, situations may occur that lead to failures of one or more components, such as valve breakage, spot corrosion, loss of tightness of internal or external seals, formation of internal scales, among others.

The causes of failures can originate in several situations, such as out-of-design pressures, failure in the locks, uncontrolled installation or operation, dirty or defective sealing zones, component misalignment and excessive loads, corrosive or abrasive fluid flows that are incompatible or out of specification.

In some cases of loss of tightness in the seals of flanges and connectors, when the internal pressures are greater than the hydrostatic pressure, part of the fluid being flowed may leak. Due to the high pressures and low viscosity, it is common for natural gas to leak, mainly in the form of small bubbles.

In this scenario, the accumulation of hydrate in the external region of subsea pieces of equipment, caused by the undue leak of natural gas in defective seals is a known problem for the offshore industry in the area of oil and gas exploration. The presence of hydrate in valve interfaces and actuators, control lines, or electric and hydraulic connector interfaces can hinder, or even prevent, the functioning of these devices.

These situations cause losses related to additional time in operations of specialized vessels and rigs during the intervention, or, in extreme cases, can generate delays in the beginning or restart of production, which causes high financial losses to operators.

The pieces of equipment currently designed for heating fluids in a subsea environment are large, require long mobilization periods and high costs with works in shipyards.

There are several techniques in the state of the art that aim to solve this problem in several different ways.

One of the techniques currently used consists of the production of hot water on the vessel, in which the water is heated by means of an electric resistance or boiler located on the vessel, and later filled in a thermally insulated tank or pumped through a thermally insulated pipe by the seabed to the piece of equipment.

In the case of filling into a tank, it is submerged via a winch or crane. Once at working depth, an ROV connects a hose to the tank, and pumps the heated fluid over the hydrate, using conventional jetting techniques.

However, this technique has a number of disadvantages, as presented below: the highest temperature of the fluid is limited to the boiling temperature on the surface (100° C. for water); during the immersion and descent excursion of the tank, even if it is thermally “insulated”, a part of the heat is lost due to the time of the descent maneuver of the tank; if there is a need for a greater amount of fluid, it will be necessary to carry out additional maneuvers of tank recovery, heating and descent, wherein the ROV ascent and descent maneuvers consume time and generate other significant costs; and there is a risk of accident, with personal injury (burns), during the heating maneuvers and transfer of the heated fluid to the tank.

Another known technique would be the production of hot water in the subsea environment with electric power supply directly by the vessel. In this technique, a set consisting of a tank, sensors, pump and electric resistances, is launched via a tiltable gantry with an armored cable. Once at actuation depth, an ROV connects a hose to the piece of equipment and begins the process of pumping and jetting the heated fluid.

However, this technique also has a number of disadvantages, such as: demand for major works on the deck of the vessel (A-frame and container for generation, filtering or conditioning of electric energy), with considerable costs of mobilization, approval by certifying companies and demobilization; it requires the provision of a custom-designed armored cable; it requires a maintenance plan and packaging of the more complex piece of equipment; it generates deck movement with heavy loads and associated risks; furthermore, it uses seawater as the only working fluid.

Yet another known technique is the production of hot water in the subsea environment with electric power supply directly by the ROV. In this technique, as described by document US2016/0258653A1, a heating skid is mounted on the ROV, which consists of floats, tank, transformer, sensors, control electronics, pump, hose and electric resistors.

However, this technique also has a number of disadvantages, such as requiring modifications to the ROV electric circuit to include switching circuits and shunting of high voltage lines (˜3000 V); for large powers, the weight of the transformer imposes considerable loads on the ROV structure; during pumping, the tank is filled with a cold fluid, which mixes with the one to be injected, that is, the temperature of the fluid drops during the injection phase.

Therefore, there is still a great demand for the development of more efficient devices to counteract hydrate formation in subsea oil and gas exploration pieces of equipment.

There are also other documents of the state of the art that aim to solve the described problem, as will be presented below.

Document U.S. Pat. No. 6,955,221B2 discloses a method of active heating of thermally insulated hydrocarbon flow lines. According to this document, heated liquid, preferably hot water, is passed along a ring, either along a single tube or multiple tubes installed in an insulating ring or along an inner ring formed by a pipe of water added concentrically around the internal hydrocarbon transport duct.

Document WO2015197784A3 discloses a method and device for transporting production fluid from a well, wherein the production fluid can be pumped through a pipeline to generate frictional heat to protect the fluid against hydrate formation and wax deposition.

Document U.S. Pat. No. 7,381,689B2 discloses a method and an amide composition used to inhibit, delay, mitigate, reduce, control and/or postpone the formation of hydrocarbon hydrates or hydrate agglomerates. The described method can be applied to prevent or reduce or mitigate the hydrate formation in the fitting of ducts, pipelines, transfer lines, valves and other places or pieces of equipment where hydrocarbon hydrate solids can form.

Document US20150114655A1 discloses a method for preventing the formation of gas hydrates in a BOP in deep water well operations, which includes adding at least 28% glycol, by volume, to a BOP fluid. Thus, the hydrate phase equilibrium line is shifted to the point where operating conditions will not form a hydrate.

Document U.S. Pat. No. 6,415,868B1 discloses a method and an apparatus for preventing the formation of alkane hydrates in subsea pieces of equipment. This document specifically describes that the invention incorporates a temperature control device to prevent the formation of alkane hydrates in a component of subsea oil and gas production piece of equipment that has at least one flow path through which a well fluid is allowed to flow.

As can be seen, the presented documents of the state of the art disclose different methods to counteract hydrate formation in subsea oil production pieces of equipment known from the state of the art. However, it is clear that the state of the art still has possibilities for the development of more efficient alternatives to counteract hydrate formation in pipes.

In particular, the state of the art lacks an efficient method for hydrate counteraction, wherein the hydrate formation is counteracted by heating the fluid inside ducts simultaneously with the pumping of this fluid.

As will be further detailed below, the present invention aims to solve the problems of the state of the art described above in a practical and efficient way.

### SUMMARY OF THE INVENTION

The objective of the present invention is to provide a modified pump in which, inside the modified pump, the pumping and heating of the fluid occur simultaneously in its interior in a practical and efficient way.

In order to achieve the objectives described above, the present invention provides a centrifugal pump for heating fluid by eddy current comprising a volute and a cover, wherein internally regarding the volute there are provided: an impeller positioned between two supporting annular discs of magnet each comprising a plurality of permanent magnets; and two armatures positioned at the ends of the internal assembly.

The present invention further provides a subsea tool for fluid heating by eddy current comprising: a centrifugal pump driven by a hydraulic motor by means of a shaft; a fluid storage tank hydraulically connected to the centrifugal pump; at least one piloted on-off valve; piloted directional valves; and a filter hydraulically connected to the centrifugal pump.

### BRIEF DESCRIPTION OF THE FIGURES

The detailed description presented below makes reference to the attached figures and their respective reference numbers.

FIG. 1 illustrates a schematic diagram of an optional configuration of the subsea tool for fluid heating by eddy current of the present invention.

FIG. 2 illustrates a view of an electronic bottle according to an optional configuration of the present invention.

FIG. 2a illustrates the fluid storage tank illustrated in FIG. 1 in the empty condition.

FIG. 3 illustrates a centrifugal pump with fluid heating by eddy current function according to an optional configuration of the present invention.

FIG. 3a schematically illustrates the polarity arrangement of the magnets responsible for inducing eddy currents in the pump impeller illustrated in FIG. 3.

FIGS. 4a and 4b illustrate two possible embodiments of mounting the tool of FIG. 1 in the structure of an ROV.

### DETAILED DESCRIPTION OF THE INVENTION

Preliminarily, it should be noted that the following description will start from a preferred embodiment of the invention. As will be apparent to any technician skilled on the subject, however, the invention is not limited to that particular embodiment.

Considering the demand for more effective methods of dissociating hydrates in an external environment to the subsea pieces of equipment, cleaning surfaces and removing heat-sensitive scales (paraffins, greases, resins and the like), and also considering the space restriction available in the structure of the ROV and the availability of hydraulic power, the invention that will be described below consists of a simple tool, installed and operated by an ROV.

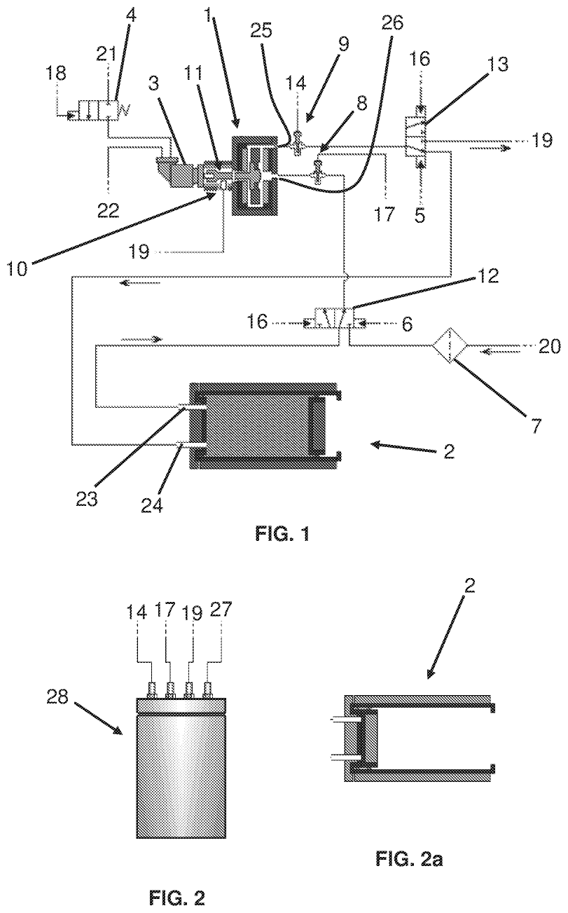

FIG. 1 illustrates a schematic diagram of an optional configuration of the subsea tool for fluid heating by eddy current of the present invention. In this figure, it is possible to observe the interconnection between the various components of the tool.

In general, the tool comprises: a modified centrifugal pump with heating function 1; a fluid storage tank 2; a hydraulic motor 3; a piloted on-off valve 4; piloted directional valves 12, 13; a filter 7; temperature sensors 8, 14; and a rotation sensor 10.

FIG. 2 illustrates a view of an electronic bottle 28 according to an optional configuration of the present invention. FIG. 2a illustrates the fluid storage tank 2 of FIG. 1 in the empty condition.

More generally, the fluid storage tank 2 comprises a hermetic bottle 28, resistant to collapse, containing the electronics responsible for reading signals from sensors that make up the invention.

The details of these elements will be presented and described in detail later in this specification.

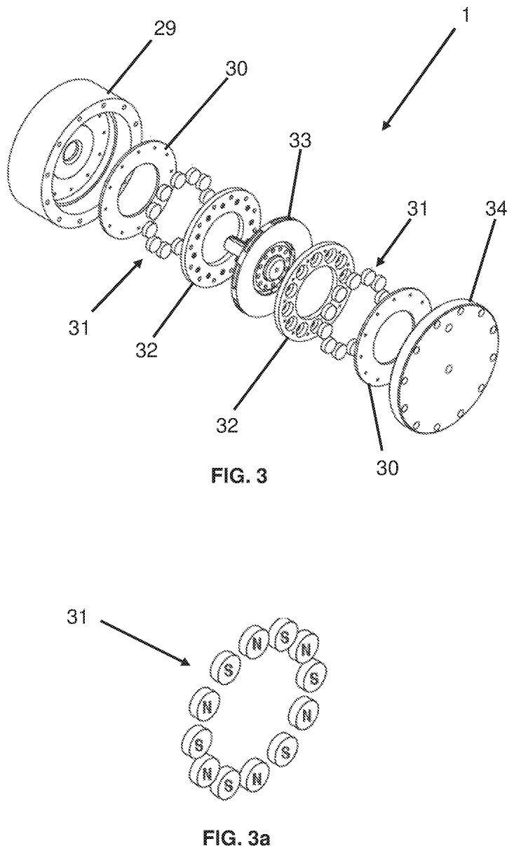

FIG. 3 illustrates a centrifugal pump 1 with fluid heating by eddy current function according to an optional configuration of the present invention. FIG. 3a schematically illustrates the polarity arrangement of the magnets responsible for inducing eddy currents in the pump impeller.

It is observed that the pump consists of a volute 29 and a cover 34, optionally manufactured in a material of low thermal conductivity and good mechanical strength. The pump 1 further comprises internally regarding the volute 29 an impeller 33 positioned between two annular support discs 32 of magnets each comprising a plurality of permanent magnets 31, and two armatures 30 positioned at the ends of the internal assembly.

Thus, the volute 29 and the cover 34 provide good thermal insulation to the pump 1, preventing heat loss to the external environment and increasing the efficiency in heating the pumped liquid, as will become more evident with the following description.

In addition, the impeller 33 is preferably made of a material with good thermal and electric conductivity.

The ring disks 32 of magnet support have the function of holding the magnets 31 and reducing free spaces.

The armature 30 optionally consists of a material with good magnetic permeability.

From this configuration, the heating principle of the pumped liquid is given by the combination of the effects of induced electric current (eddy or Foucault current), Joule effect and heat transfer, mainly by the forced convection between the impeller (hot part) and the fluid (cold part). Also, the induced electric current is due to the positioning of the magnets, as will be further detailed in this specification.

In this way, inside the modified pump, the fluid is pumped while generating and transferring heat to the same.

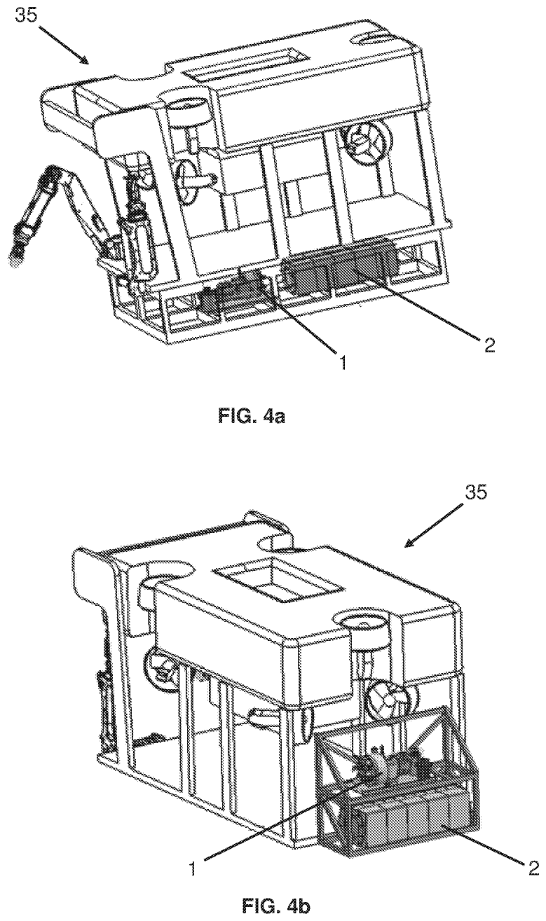

FIGS. 4a and 4b illustrate two possible embodiments of mounting the tool of FIG. 1 on the structure of an ROV 35. According to these optional embodiments, the tool can be applied to a structure attached to the bottom (FIG. 4a), or to a structure attached to the rear (FIG. 4b) of an ROV 35.

The details and alternative configurations will be presented below, based on the configurations shown in the attached figures.

Optionally, the control valve (piloted on-off valve 4) of the subsea tool for fluid heating by eddy current represented in FIG. 1 is of the two-way, two-position type, normally closed with spring return, and is hydraulically piloted through the pressure line 18.

The function of the piloted on-off valve 4 is to allow the passage of hydraulic fluid from the high pressure/high flow rate line 21 of the ROV to feed the hydraulic motor 3. In other words, the hydraulic line 18, when pressurized, has as a final objective to turn on the modified bomb 1.

The subsea tool for fluid heating by eddy current further comprises a hydraulic motor 3 comprising feed lines connected to the control valve 4 and the return line 22 to the ROV tank. The hydraulic motor has the function of supplying mechanical energy to a shaft 11 of the modified pump 1.

The shaft 11 of the modified pump 1 has the main function of transmitting mechanical power to the impeller 33 of the pump 1. In addition, the shaft 11 can serve as a monitoring element for the rotation of the pump 1 with the use of a rotation sensor 10.

Thus, a rotation sensor 10 can also be adopted with the function of detecting the movement of the shaft 11 and sending the recorded signals to an electronic bottle 28, through an electric cable 19, or another form of communication.

The centrifugal pump 1 of the present invention is adapted to perform the pumping of liquid by means of a centrifugal impeller 33, as already presented earlier in this specification, which is positioned between two matrices of permanent magnets 31.

In addition, the magnets 31 are arranged so that an electric current is induced in the impeller. In other words, the magnets 31 are positioned so as to comprise opposite polarity with respect to neighboring magnets.

Additionally, an armature 30 consisting of a material with good magnetic permeability is in contact with the magnets 31.

Thus, the annular disks 32 of supporting magnets 31 have the function of holding the magnets 31 in their positions and filling the spaces between the same. For this, the annular disks 32 supporting the magnets 31 optionally comprise cavities with the same geometry as the magnets 31.

Thus, during the operation of the centrifugal pump 1, the impeller 33 is rotated within a magnetic field generated by the magnets 31, in order to generate an eddy current in the impeller body 33, an effect known as Foucault current.

Combined with the Joule effect, electric energy is converted into heat, which heats the impeller 33, so that heat is transferred to the pumped fluid by thermal dissipation. Thus, the fluid is heated extremely efficiently and without the need for a large expenditure of energy.

The subsea tool for fluid heating by eddy current further comprises a directional valve 12 installed upstream of the pump 1, adapted to select the origin of the fluid inserted into the pump 1 through the fluid inlet opening 26. Thus, fluid can be drawn from the fluid storage tank 2 or from the filter 7.

Optionally, as seen in FIG. 1, the directional valve 12 has hydraulic piloting in both directions, in which the piloting of this valve 12 is done by the ROV 35.

Thus, when the hydraulic line 16 is pressurized at the same time as the hydraulic line 6 is depressurized, the pump 1 collects the fluid from the filter 7.

On the other hand, when the hydraulic line 16 is depressurized at the same time as the hydraulic line 6 is pressurized, the pump 1 collects the fluid from the tank 2.

A second directional valve 13 can still be installed downstream of the pump, at the heated fluid outlet 25, to direct the outlet of the heated fluid. The fluid can also be directed to the tank 2 or to the external piece of equipment 19.

As seen in FIG. 1, the valve 13 has hydraulic piloting in both directions. The piloting of this valve is also done by the ROV 35, according to the preferred embodiment described herein.

Accordingly, when the hydraulic line 15 is pressurized at the same time as the hydraulic line 5 is depressurized, the pump 1 sends heated and pressurized fluid to the external piece of equipment 19.

On the other hand, when the hydraulic line 15 is depressurized at the same time as the hydraulic line 5 is pressurized, the pump 1 sends the heated fluid to the tank 2.

The invention further provides that the piloting of valves 12, 13 is not limited only to the described configuration (by hydraulic pressure). Piloting can also be performed by solenoids. A technician skilled on the subject will be able to determine the best form of embodiment according to each application.

Optionally, a pump output temperature sensor 9 is installed downstream of the pump 1, where the signal from the temperature sensor 9 is sent to the electronic bottle 28 via the electric cable 14.

Additionally, a pump inlet temperature sensor 8 can be installed upstream of the pump 1. The signal from the temperature sensor 8 is also sent to the electronic bottle 28 via the electric cable 17.

The electronic bottle 28 receives this designation because it is a hermetic vessel, with elastomeric seals, resistant to the collapse pressure, wherein inside there are contained electronic pieces of equipment responsible for interpreting the signals from the sensors 8, 9, 10 via the electric cables 14, 17, 19, encoding and sending the same to the ROV via the electric cable 27.

Thus, the electronic bottle 28 represents a data control and interpretation system, contained in a water and pressure resistant container, which can control several elements of the described system.

The fluid accumulation tank 2 is optionally of the compensated type, with variable internal volume via piston with seals. In this case, the tank 2 would be of the tight type, with coatings of special materials that provide thermal insulation and thrust compensators (floats). Thus, the tank would be able to maintain the temperature and pressure of the liquid inside the same constant, or within desirable ranges during operation.

The description in the previous paragraph can be better observed by comparing the tank 2 illustrated in FIGS. 1 and 2a, presented above. In FIG. 1, the tank 2 is illustrated with the piston extended, a situation that occurs when the tank 2 is full. In FIG. 2a, in turn, the tank 2 is shown with the plunger retracted, in which case tank 2 would be empty.

Thus, according to everything described so far, the combination of the states of the valves 12, 13 of the subsea tool for heating fluid by eddy current of the present invention allows the following operating conditions:
a) filling the tank by collecting fluid by means of the filter 7 and ejecting it into the tank via the inlet opening 24 of the tank 2;
b) emptying the tank 2 by means of the collection of fluid internal to the tank 2, via the outlet opening 23 of the tank 2 and ejection to the piece of equipment 19;
c) fluid recirculating by means of fluid collection via the outlet opening 23 of the tank 2 and ejection to the tank 2 via the inlet opening 24; and
d) continuously ejecting by means of the collection of fluid by means of the filter 7 and direct ejection to the piece of equipment 19.

In all the operations described in the previous paragraphs, the fluid is directed to the centrifugal pump 1 with the function of heating the fluid by eddy current described above so that the heating of the fluid is performed.

As any technician with minimal knowledge of the subject would know, the collection inlet 20 of the filter 7 can be opened to the seabed or be connected to another tank via a hose and/or hot stab connectors. It can work with different types of fluids: sea water, glycols or water-based hydraulic fluids.

Additionally, the output of the piece of equipment 19 can be connected to a hose with or without thermal insulation, with its open end or with a hot stab connector, for discharge of the heated fluid on the surface of the subsea piece of equipment or injection into the same.

The components of the invention described were sized to be installed in structures attached to an ROV 35, which may be structures at the bottom of the ROV 35 (FIG. 4a) or at the rear of the same (FIG. 4b).

Numerous variations falling under the scope of protection of this application are allowed. Accordingly, it reinforces the fact that the present invention is not limited to the particular configurations/embodiments s described above.

1-6. (canceled)

7. A subsea tool for fluid heating by eddy current, comprising: a centrifugal pump driven by a hydraulic motor by means of a shaft; a fluid storage tank hydraulically connected to the centrifugal pump; at least one piloted on-off valve; piloted directional valves; and a filter hydraulically connected to the centrifugal pump, wherein the centrifugal pump is as defined by a volute and a cover; an impeller positioned between two supporting annular disks of magnets each comprising a plurality of permanent magnets; and two armatures positioned at ends of an interior of the volute.

8. The subsea tool according to claim 7, further comprising: temperature sensors adapted to measure the temperature of an inlet fluid and an outlet fluid of the centrifugal pump; and a rotation sensor adapted to measure the rotation of the shaft of the hydraulic motor, wherein the data generated by the sensors are sent to an electronic bottle, wherein the electronic bottle comprises a hermetic vessel, with elastomeric seals, resistant to a collapse pressure, wherein inside there are contained electronic pieces of equipment responsible for interpreting the signals from sensors, encoding and sending the same to an ROV.

9. The subsea tool according to claim 7, wherein the piloted on-off valve is of the two-way, two-position type, normally closed with spring return, and is hydraulically piloted by a pressure line.

10. The subsea tool according to claim 7, wherein the hydraulic motor comprises a feed line connected to a control valve and a feed line connected to a return line for the ROV tank.

11. The subsea tool according to claim 7, further comprising a directional valve installed upstream of the pump, wherein the directional valve is adapted to select a source of the fluid inserted into the pump through a fluid inlet opening, wherein the fluid can be drawn from the fluid storage tank or from the filter, and wherein the directional valve comprises hydraulic piloting in both directions, wherein the piloting of the directional valve is done by an ROV.

12. The subsea tool according to claim 7, further comprising a directional valve installed downstream of the pump, at a heated fluid outlet, adapted to direct the heated fluid outlet to the tank or to an external piece of equipment, wherein the valve is hydraulically piloted in both directions.

13. The subsea tool according to claim 7, wherein a fluid accumulation tank is of the compensated type, with variable internal volume, with coatings of materials that provide thermal insulation, and comprising thrust compensators.

14. The subsea tool according to claim 7, wherein the tool is installed on a structure attached to an ROV, wherein the structure is located at a bottom or at a rear of the ROV.
